(19) United States
(12) Patent Application Publication
(10) Pub. No.: US 2019/0071624 A1
(43) Pub. Date: Mar. 7, 2019

(54) SYSTEM AND METHOD FOR THE EXTRACTION OF ALPHA-ACIDS FROM POST-PROCESS FERMENTATION SOLIDS

(71) Applicant: Herbal Fracture, LLC, Silverthorne, CO (US)

(72) Inventors: SungTing Chen, Idaho Springs, CO (US); Landon Wagner, Dillon, CO (US)

(73) Assignee: Herbal Fracture, LLC, Silverthorne, CO (US)

(21) Appl. No.: 16/125,309

(22) Filed: Sep. 7, 2018

Related U.S. Application Data
(60) Provisional application No. 62/606,124, filed on Sep. 7, 2017.
(60) Provisional application No. 62/555,538, filed on Sep. 7, 2017.

(51) Int. Cl. C12C 3/08; B01D 11/02; B01D 3/00

(52) U.S. Cl. CPC C12C 3/08; B04C 5/14; B01D 3/001; B01D 11/0257

(57) ABSTRACT

The present invention pertains in general to a system and method for the separation alpha-acids and other desirable compounds from post-process fermentation solids which are otherwise subject to discard after being used for a fermentation process such as the brewing of beer. The system and method, although described surrounding use with alpha-acids as associated with a beer brewing process, can be used in the extraction of soluble compounds from solids generically.

### CROSS REFERENCE TO REFERENCE TO RELATED APPLICATIONS

This application claims the benefit of U.S. Provisional Patent Application 62/555,538 entitled “System And Method For The Extraction Of Alpha-Acids From Post-Process Fermentation”—filed on Sep. 7, 2017—currently pending, and U.S. Provisional Patent Application 62/606,124 entitled “System And Method For The Extraction Of Alpha-Acids From Post-Process Fermentation”—filed on Sep. 7, 2017—currently pending, the entire contents of which are incorporated herein by reference in their entirety for all purposes.

### FIELD OF THE INVENTION

The present invention pertains in general to a system and method for the separation of alpha-acids and other desirable compounds from solid hop material from post-process fermentation solids.

### BACKGROUND OF THE INVENTION

With the increased popularity of beer and beer producers, the post-process fermentation byproducts and solids generated have also increased. Solids generated by the beer brewing process are discarded post-process plant-based material. The method of disposal of post-process fermentation solids, herein referred to as “solids” varies by brewer, brewing volume and available disposal options. However, the solids discarded post process still contain compounds desirable for the brewing process that have not been used to their full potential.

Hops—the flower of the hop plant (Humuluis lupulus)—used primarily as a flavoring and stability agent in beer brewing, imparts a sometimes bitter, zesty or citric flavor. Hops have also been used for an antibacterial effect that favors activity of brewer's yeast over less desirable microorganisms. However, the characteristic and often desirable effect of hops is the taste profile, often described as bitterness, which the hopping process imparts on the beer during the brewing process.

Alpha-acids contained in hops contribute to the bitterness characteristic by “hopping” beer. During the traditional brewing process, roughly 25% of these alpha-acids are extracted leaving 75% of the alpha-acids unused and discarded post-process.

Due to increased brewing activity, hop availability has decreased. There has also been an increase in prices for quality hops. Changing weather patterns also contribute to the market availability of hops. The market variability surrounding hops has caused problems for brewers, particularly smaller brewing operations or home brewers.

Although there are processed hop products that provide alpha-acids, some brewers insist on the usage of actual hop flowers. Post-process hop flowers are discarded post-process, contributing to the waste-stream of underutilized alpha-acids from the hop flower.

Another example of post-process hop material is fermentation solids, commonly referred to as trub. Trub is a layer of sediment left at the bottom of a fermenter after the yeast has completed the bulk of the fermentation, and is discarded as a post-process byproduct. Trub contains post-process hop material. Fermentation solids contain components including heavy fats, proteins and inactive yeast as well as unutilized alpha-acids. The unutilized alpha-acid content of solids may be as high as 75-percent of the original alpha-acid content of the pre-process solids. As such, there is a need for capturing the unutilized alpha-acids from post-process solids.

### SUMMARY OF THE INVENTION

The present invention surrounds a method and system for the extraction of compounds, such as alpha-acids, from post-process solids or solid byproduct of the brewing process. Extracting alpha-acids from post-process solids allows the sale and use of a portion of the post-process byproducts otherwise disposed of in a waste-stream. In turn, sale and use of post-process byproducts alleviates some of the problems associated with market availability of hops for the brewing process. Embodiments of the present invention extract alpha-acids from post-process hop material in crystalline form.

The standard brewing process typically involves adding hop material to a brewing process during a boiling stage. This utilizes up to 25% of the alpha-acid content from the hop material. The boiling process is typically unable to extract more alpha-acids without a negative effect. Extending the boiling stage beyond the point at which 25% of the alpha-acid contents are utilized releases unwanted compounds. The unwanted compounds are associated with undesirable flavors in the beer. Thus, hop material is not efficiently utilized. Certain existing techniques, such as that described in U.S. Pat. No. 4,282,259 to Wheldon, et al. (incorporated by reference herein in its entirety) use carbon dioxide to extract alpha-acids from unprocessed hops to provide a concentrated liquid extract. Concentrated hop extracts are typically used to simplify adding hop content to a brewing process. Such extracts fail to address unused alpha-acids found in post-process hop material. Furthermore, such hop extracts are sometimes an oil or wax, which may be difficult to work with due to a time-consuming process of mixing to achieve a homogenous solution during the brewing process.

Discarding the post-process hop material wastes the remaining hopping potential of post-process hop material. Existing solutions do not address the problem of unutilized alpha-acids in post-process hop material.

Certain embodiments of the present invention comprise a system to extract alpha-acids from post-process solids to produce a powder alpha-acid additive for brewing processes. Such a system includes a solvent reservoir, a raw material reservoir, a dehydrator, a mixing mechanism, a pump, a filtering unit, a distilling unit, and a solvent recapture reservoir. It will be appreciated that a dehydrator may include any dehydration apparatus known to those skilled in the art, including as disclosed by U.S. Pat. No. 5,592,873 to Lee et al., incorporated by reference herein in its entirety. The dehydrator removes excess fluid content from the post-process solids. The excess fluid content can be removed prior to or following mixing post-process solids with a solvent. The solvent, from a solvent reservoir, dissolves desired compounds from the post-process solids such as, but not limited to, alpha-acids.

In certain embodiments, a dehydrator can comprise a dual screw dehydrator apparatus. Such embodiments comprise a specialized separator to remove solids from liquids at an optimized material particle size. The dehydrator ejects a dehydrated plant-based material while separating and filtering the liquids. For instance, a 20-40 micron (0.787-1.57×10⁻³ inch) screen may be used to increase restriction on the liquid output to ensure high pressure and full removal of solids larger than 40 microns (1.57×10⁻³ inch). Other embodiments comprise a dehydrator press a slurry against a 20-40 micron (0.787-1.57×10⁻³ inch) stainless steel screen.

In certain embodiments, a mixing mechanism mixes solvent and post-process solids to create a substantially homogeneous slurry. This saturates the solvent with dissolvable compounds, such as alpha-acids. The mixing mechanism, in certain embodiments, comprises a closed loop, recirculating pump, and output valve. In other embodiments, the mixing mechanism utilizes a motorized mixer with a mixing element. It will be appreciated that other embodiments of a mixing mechanism may comprise other mixing apparatuses or mixing methods known to those skilled in the art.

Certain embodiments comprise a filtering unit that removes post-process solids from a slurry leaving the solvent saturated with the dissolved compounds such as alpha-acids. It may be desired to connect a first filtering unit output to a first distilling unit input to deliver the saturated solvent to the distilling unit.

Certain embodiments comprise a distilling unit having a heating element to heat the diluted solvent mixture to, or exceeding, the boiling point of the solvent, but below the boiling point of water. The heating element creates a vapor state of the solvent, where the vapor proceeds upward into a still head. The vapor is cooled by a condensing unit within the still head, condensing the solvent which is then directed toward a condensate capture feature. The solvent is captured by the condensate capture feature and directed toward a chiller unit. The chiller unit cools the solvent prior to the solvent being transferred to a solvent recapture reservoir, for the collection and future reuse of the solvent. The condensing unit and the chiller unit each provide cooling using a cooling fluid which flows through a heat-exchanger. The cooling fluid is maintained at a temperature lower than the boiling point of the solvent, and typically cooler than the ambient temperature, to cool the condensing unit and chiller unit. As such, the cooling action of the condensing unit and chilling unit cools the air and vapor which interacts with the condensing unit and chilling unit. In certain embodiments, the same cooling fluid circulates through both the condensing unit and the chiller unit in series or parallel. It will be appreciated that in other embodiments, a chiller unit and condensing unit may have independent cooling supplies. After the separation of the solvent from the diluted solvent mixture, a remaining solution including alpha-acids and a fluid, such as water, is transferred to a separation mechanism, such as spray-dryer, for the separation of the fluid and alpha-acids.

Certain embodiments comprise a drying apparatus comprising a nozzle or injector to deliver the solution into a drying chamber. The solution is delivered to the drying chamber in an aerosol or atomized form to create droplets of the solution. The drying chamber, having a temperature elevated above the ambient temperature, encourages evaporative separation of the alpha-acid crystals from the solution. Certain embodiments comprise a drying apparatus having a spinning injector and drying chamber to encourage the evaporation of fluid from the solution. The evaporation of the fluid leaves crystalline alpha-acids, which are captured within the drying chamber. An air-pump provides a pressure differential. The pressure differential allows the spray-dryer to maintain air-flow through the drying chamber. Certain embodiments comprise a spray-dryer having a secondary separation mechanism, such as a cyclonic separator as disclosed by U.S. Pat. No. 3,802,570 to Dehne, incorporated by reference herein in its entirety. A secondary separation mechanism may be used to capture crystals that are too small to be deposited within the drying chamber.

Certain embodiments of the present invention surround a method for extracting alpha-acids from post-process solids comprising the steps of: mixing the post-process solids with a solvent, mixing the combination of the post-process solids with solvent to create a slurry, separating a solution from the slurry, diluting the solution, distilling the solution, settling any sediment, cooling the solution, and drying the solution prior to the step of collecting of dried alpha-acid crystals. It will be appreciated that these steps may be executed in alternative orders without departing from the spirit of the present invention.

In certain embodiments, a dehydrating step occurs prior to a mixing step to remove water content from the post-process solids prior to the addition of a solvent. This limits the dilution of a solvent by pre-existing water in the post-process solids. Once the liquid content is separated from the captured sediment a solvent is added to the captured sediment. The addition of a solvent creates a hop slurry to dissolve desired by-products such as alpha-acids. The slurry is then agitated to ensure proper solvent saturation. In certain embodiments, post-process solids are mixed with a solvent prior to dehydrating the post-process solids.

The step of mixing post-process solids with a solvent dissolves the desired alpha-acids of the post-process solids into solution. The solvent dissolves the alpha-acids. The post-process solids can be later discarded without the loss of alpha-acids. Separating post-process solids from the slurry separates fluids in the slurry, such as water or solvent, from the solids. Once the solution is separated from the slurry, the sediment portion of the slurry can be discarded. If desired, the solution is diluted with water in preparation for a distillation process after separating the solution from the slurry, such as with a dehydrator. During the distilling process, the solution is elevated in temperature to separate the solvent from the solution. Heating the solution, sometimes to boiling, transitions the solvent into a vapor state. The solvent typically has a lower boiling point than that of water. Certain embodiments include a solvent such as ethanol and a fluid such as water. The vapor outlet has a temperature above the boiling point of the solvent but below the boiling point of the water. If water vapor passes through the vapor outlet, the temperature of the vapor outlet causes the water vapor to condense and return to the solution while the solvent vapor passes through the outlet for recapture. This separates the solvent vapor from the water vapor.

Once the solvent is removed is from the solution, the solution contains alpha-acids and water. The solution then goes through a settling process, allowing any alpha-acids that have precipitated out of solution to settle out of suspension within the remaining solution. Once the settling process is complete, the solution is dried to separate the water content from the remaining alpha-acid crystals in preparation for collecting the crystals.

In certain embodiments of the invention, drying comprises pressurized delivery of the solution through a spray nozzle in a reduced humidity and heated environment. In certain embodiments the ambient humidity during the drying press does not exceed 20% humidity. The drying dehydrates the solution, leaving crystalline alpha-acids deposited into a collection vessel. The spray nozzle is positioned so the crystalline alpha-acids are deposited into a collection vessel inside the drying apparatus. Crystalline alpha acids are transferred from the collection vessel for packaging. In certain embodiments, the crystalline alpha-acids may require mechanical removal from collection vessel surfaces. The removal may comprise scraping or other methods appreciated by those skilled in the art. Scraping can be performed with a variety of different objects and materials, but is typically performed with a food grade, durable and flexible product such as polytetrafluoroethylene (PTFE) sheet material. Once the crystalline alpha-acids are removed from the collection vessel, the crystalline alpha-acids are packaged. The packaging is typically one that can be sealed from the ambient environment, such as a hermetically sealed container, to prevent effects from ambient humidity.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF FIGURES

FIG. 1A—A diagrammatic view of certain embodiments of a system for the extraction of alpha-acids from post-process fermentation solids

FIG. 1B—A diagrammatic view of a dehydrator

FIG. 1C—A diagrammatic view of a mixing mechanism and filtering unit

FIG. 1D—A diagrammatic view of a distilling unit

FIG. 2A—A diagrammatic system view of certain embodiments of a system for the extraction of alpha-acids from post-process fermentation solids

FIG. 2B—A diagrammatic view of a mixing mechanism and dehydrator

FIG. 2C—A diagrammatic view of a distilling unit

FIG. 2D—A diagrammatic view of a drying apparatus

FIG. 3—A method for the extraction of alpha acids from post-process solids

### DETAILED DESCRIPTION

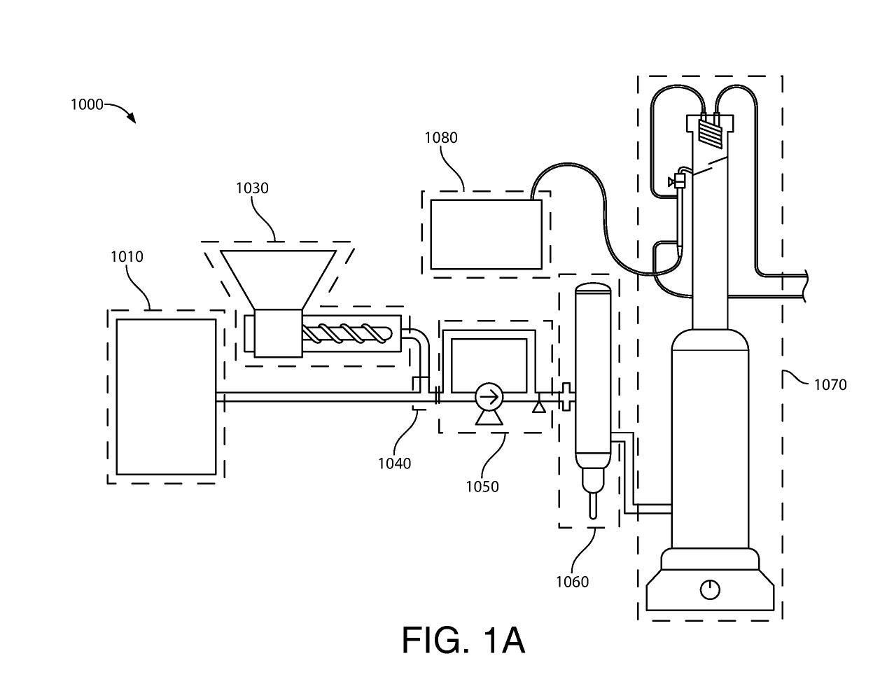

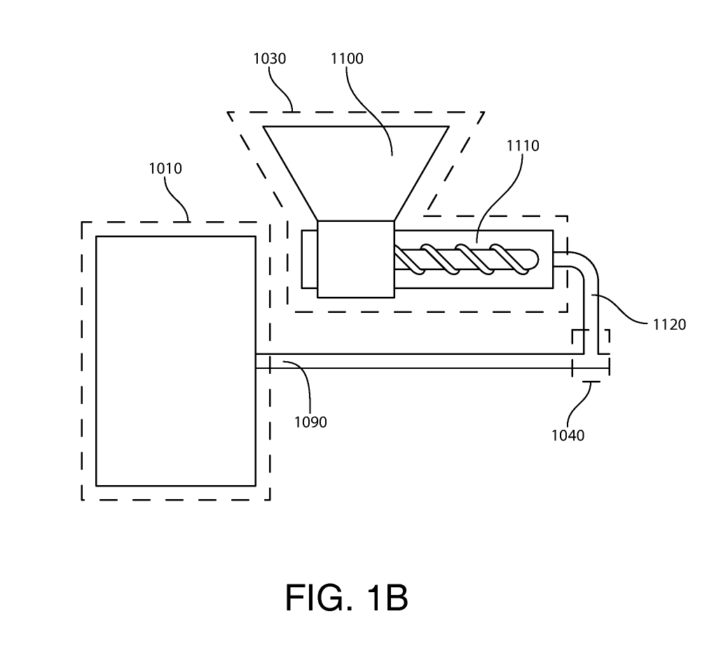

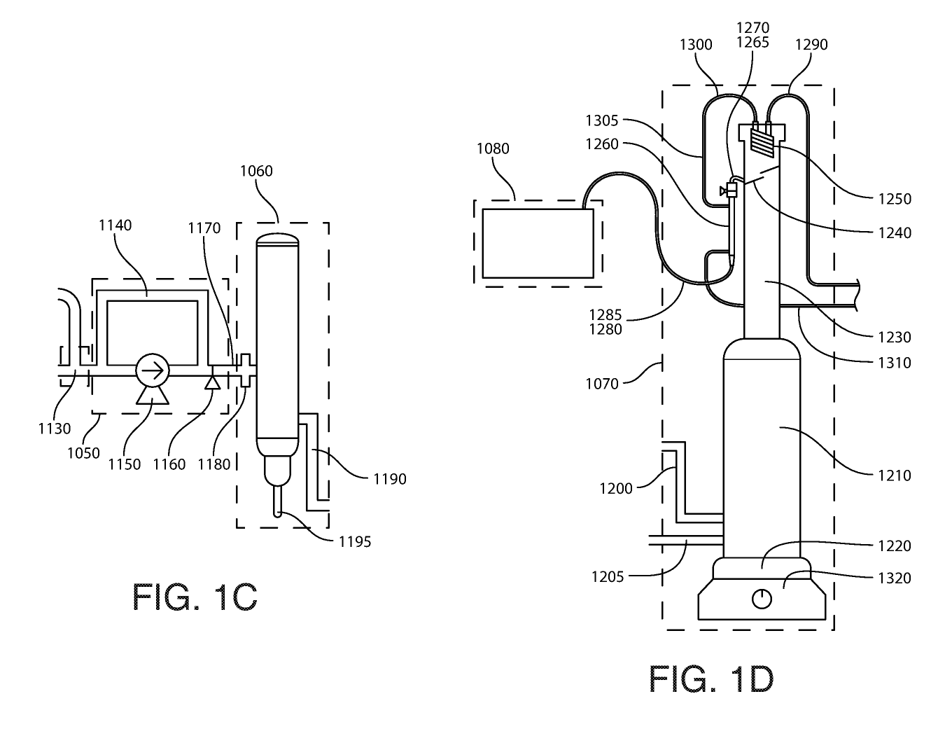

Certain embodiments as shown in FIG. 1A comprise a system to extract alpha-acids from post-process solids having a solvent reservoir 1010, a dehydrator 1030, a mixing mechanism 1050, a filtering unit 1060, a distilling unit 1070, and a solvent recapture reservoir 1080. In certain embodiments, shown in FIG. 1B, comprise a raw material reservoir 1100, the dehydrator 1030 and a dehydrator output 1120. The raw material reservoir 1100 feeds post-process solids to the dehydrator 1030, which is configured to separate water content from post-process solids. It will be appreciated that a dehydrator 1030 may include any dehydration apparatus known to those skilled in the art including, but not limited to a dehydrate extruder. A dehydrator output 1120 is connected to a solvent reservoir output 1090 at a mixing point 1030. The mixture of solvent and dehydrated post-process solids enters the mixing mechanism 1050 through a mixing mechanism input 1030 as shown in FIG. 1C. In some embodiments, the mixing mechanism 1050, comprises a closed loop 1140, recirculating pump 1150, and output valve 1160. The mixture of solvent and post-process solids is recirculated with the recirculating pump 1150 around the closed loop 1140 to create a slurry. The output valve 1160 is actuated to allow the mixture to exit the mixing mechanism 1050. It will be appreciated that other embodiments of a mixing mechanism 1050 may comprise other mixing mechanisms known to those skilled in the art. When the output valve 1060 is opened, the slurry passes through an output 1170 of the mixing mechanism 1050, through a filtering unit input 1180, and into a filtering unit 1060. The filtering unit 1060 is configured to remove post-process solids from the slurry leaving behind the saturated solvent comprising solvent and alpha acids. A first filtering unit output 1190 is connected to a first distilling input 1200 of a distilling unit (shown in FIG. 1D). The filtering unit 1060 further comprises a second filtering unit output 1195 for the removal of post-process solids from the system for disposal.

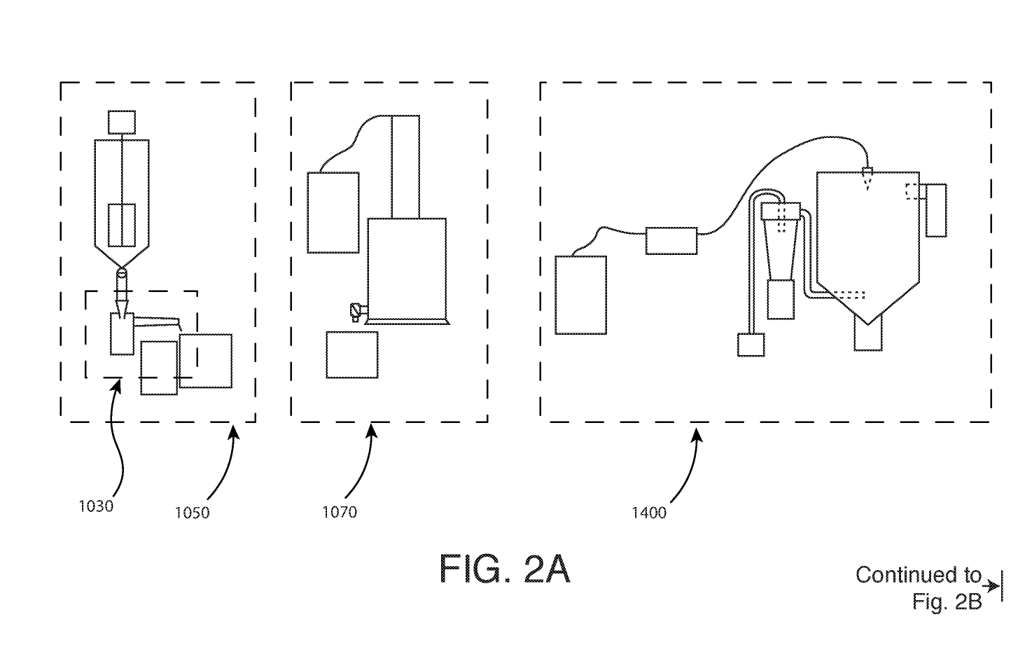

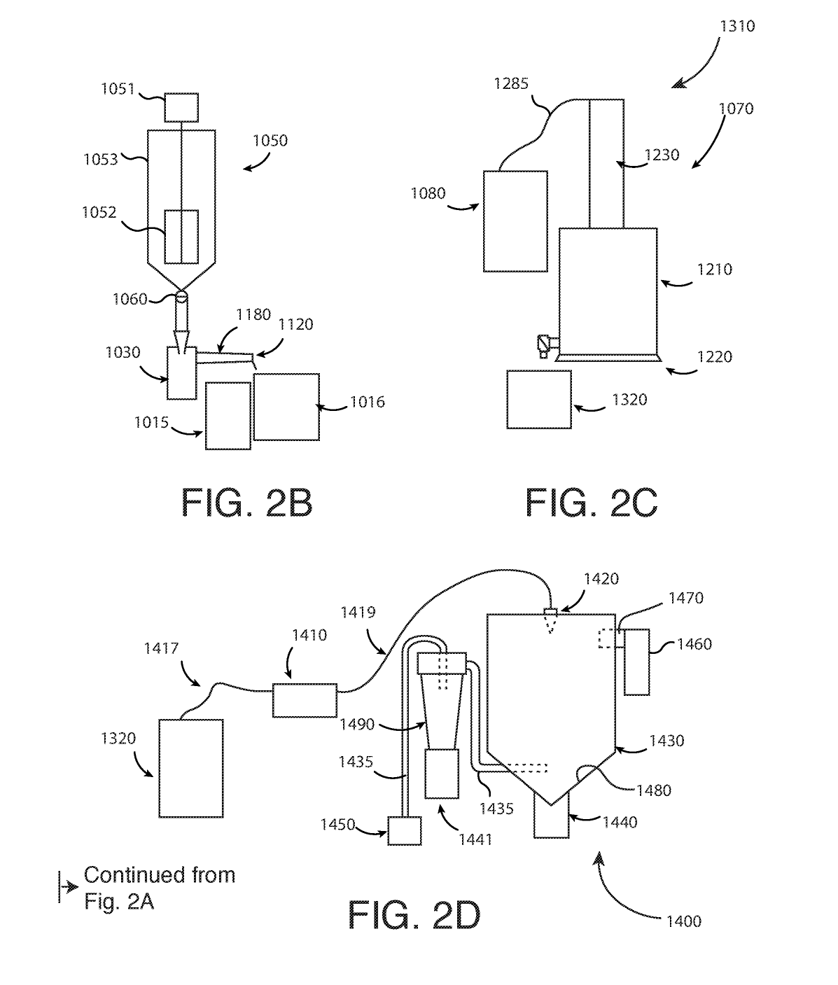

Certain embodiments, shown in FIG. 2A, comprise a dehydrator 1030, a mixing mechanism 1050, a distilling mechanism 1070, and a drying apparatus 1400. Such embodiments are directed toward the extraction of alpha-acids from post-process solids.

In certain embodiments, as shown in FIG. 2B, a mixing mechanism 1050 comprises a mixing motor 1051 and mixing element 1052 extending into a mixing reservoir 1053. Within the mixing reservoir 1053, solvent may be combined with post-process solids to create a slurry. Once combined, the slurry passes through a valve 1060 to a dehydrator 1030. The dehydrator 1030 separates post-process solids from a solution. The solution comprises solvent and dissolved alpha acids. In certain embodiments, a dehydrator 1030 comprises a filtering unit 1180 allowing separation of particulate matter which may remain in the solution after passing through the dehydrator 1030. In such embodiments, the liquid content is filtered by the filtering unit 1180 and directed into a solution reservoir 1015. The post process-solids exit a dehydrator output 1120 and deposited into a post-process solid holding chamber 1016.

Certain embodiments of the present invention, shown in FIG. 1D and FIG. 2C, comprise a distilling unit 1070 for the separation of a solvent or other liquid from a solution. In certain embodiments, a solution comprising water and alpha-acids, from of the dehydrator 1030 of FIG. 2B, is added to the distilling unit 1070, of FIG. 2C, for the separation of a solvent from the solution. A distilling unit as shown in FIG. 2C further comprises a distilling chamber 1210, a heating element 1220, a still head 1230, a solvent recapture output 1285. After the distillation process, the captured solvent is directed through the solvent recapture output 1285 into a solvent recapture reservoir 1080, and a solution comprising water and the alpha acids are output to a holding vessel 1320.

It will be appreciated that a distilling unit 1070 as shown in FIG. 1D and FIG. 2C may comprise distilling units known to those skilled in the art such as, but not limited to, U.S. Pat. No. 1,833,717 to Laird, incorporated by reference in its entirety for all purposes. It will be further appreciated that the distilling unit of the present invention typically employs simple batch distillation methods, but may alternatively use other distillation methods such as, but not limited to fractional distillation, steam distillation, or vacuum distillation.

In certain embodiments of the present invention, a distilling unit as shown in FIG. 1D, separates a solvent from a solution comprising solvent and water. The distilling unit 1070 comprises a distilling chamber 1210 and a heating element 1220. A solution contained in the distilling chamber 1210 is heated by the heating element 1220 to heat the solution to, or exceeding, a boiling point of the solvent, but below the boiling point of water. The solvent transitions to a vapor state and proceeds upward into a still head 1230. The still head 1230 further comprises a condensate capture feature 1240 and a condensing unit 1250. The condensing unit 1250 cools the temperature of the still head 1230 to a level where the solvent entering the still head 1230 condenses and falls toward the condensate capture feature 1240. The condensate capture feature 1240 directs the condensed solvent toward a first distilling unit output 1265 of the distilling unit 1070, and into a first chiller unit input 1270 of a chiller unit 1260. The chiller unit 1260 provides cooling for the captured solvent. The solvent then passes through a first chiller unit output 1280 and into a solvent recapture reservoir input 1285 of a solvent recapture reservoir 1080 for the recapture and reuse of the solvent. It will be appreciated that a cooling fluid or refrigerant is cycled through such features as a chiller unit 1260 or a condensing unit 1250 to provide cooling action to the process as disclosed. It will be appreciated that cooling fluid may comprise a gas such as air, nitrogen, hydrogen, or other cooling fluid gasses known to those skilled in the art, or a liquid such as water, glycol, oils, Freon®, or other cooling fluids known to those skilled in the art.

In certain embodiments as seen in FIG. 1D, cooling fluid is supplied to the condensing unit 1250 through a first condensing unit input 1290. The cooling fluid exits the condensing unit 1250 through the first condensing unit output 1300 and into a second chiller unit input 1305 of the chiller unit. The cooling fluid then passes through the chiller unit 1260 to cool the captured condensed solvent. The cooling fluid then exits the chiller unit 1260 through a second chiller unit output 1310. It will be appreciated that in other embodiments, a chiller unit 1260 and condensing unit 1250 may have independent cooling fluid supplies. It will be appreciated that a condensing unit 1250 and chiller unit 1260 both act to cool a gaseous or liquid state material. It will be further appreciated that a chiller unit 1260 and condensing unit 1250 may use cooling strategies known to those skilled in the art including, but not limited to, cooling strategies used by a Liebig condenser, a West condenser, an Allihn condenser, a Davies condenser, a Graham condenser, a coil condenser, a Dimroth condenser, a spiral condenser or Friedrichs condenser. Once the solution has been distilled, the remaining water and alpha acid crystals are held in the holding vessel 1320. The mixture of water and alpha acids may then be transferred to a drying apparatus.

Certain embodiments, as shown in FIG. 1D, comprise a first distilling unit input 1200 and a second distilling input 1205 through which a solution and additional water may be added. This allows for the addition of water or fluids, gasses or materials to the solution held in the holding vessel 1320, prior to or following the distillation process.

Certain embodiments of the present invention comprise a drying apparatus 1400, as shown in FIG. 2D. A drying apparatus 1400 comprises a spray dryer having a pump 1410, a nozzle 1420, a drying chamber 1430, and a first collection vessel 1440. In such embodiments, a pump 1410 delivers a solution comprising a solvent and a solute, such as water and alpha-acid crystals to the nozzle 1420. The pump 1410 draws the solution from a holding vessel 1320 through a pump inlet line 1417. The solution passes through the pump 1410, then through a nozzle inlet line 1419 to the nozzle 1420. The nozzle 1420, generates small droplets to increase the surface area of the solution. Certain embodiments comprise a nozzle 1420 having a spinning functionality wherein the nozzle 1420 provides a 360-degree delivery of droplets to more equally distribute droplets throughout the drying chamber 1430. The drying apparatus 1400 further comprises a system air-pump 1450, an air-inlet 1460, and an air-heater 1470. The system air-pump 1450 creates a vacuum to draw air through the air-inlet 1460 and across an air-heater 1470. It will be appreciated an air-pump 1450 may operate to provide a negative or positive pressure air-flow. For example, the air-inlet 1460 and air-heater 1470 can provide a heated airflow in a cyclonic motion within the drying chamber 1430. When the solution droplets exiting the nozzle 1420 are exposed to the heated airflow, the solvent evaporates and the solute precipitates out of solution. The precipitated solute, such as alpha-acid crystals, are deposited on an internal surface 1480 within the drying chamber 1430 as well as in a first collection vessel 1440 located at the bottom of the drying chamber 1430. The air-flow, comprising the evaporated solvent, is then carried out of the drying chamber 1430 through a drying chamber outlet 1435 leaving behind the precipitated solute. It will be appreciated that a pump 1410 may comprise any fluid pump for the transmission of fluids from one volume to another including non-volatile pumps, peristaltic pumps, or other pumps known to those skilled in the art.

Certain embodiments as shown in FIG. 2D, comprise a cyclonic separator 1490. The cyclonic separator 1490 is disposed between the system air-pump 1450 and the drying chamber 1430 to capture solute crystals, which may be carried out of the drying chamber 1430 by air-flow due to their small size. The cyclonic separator 1490 comprises a second collection vessel 1441 wherein solutes crystals, carried out of the drying chamber 1430, are deposited.

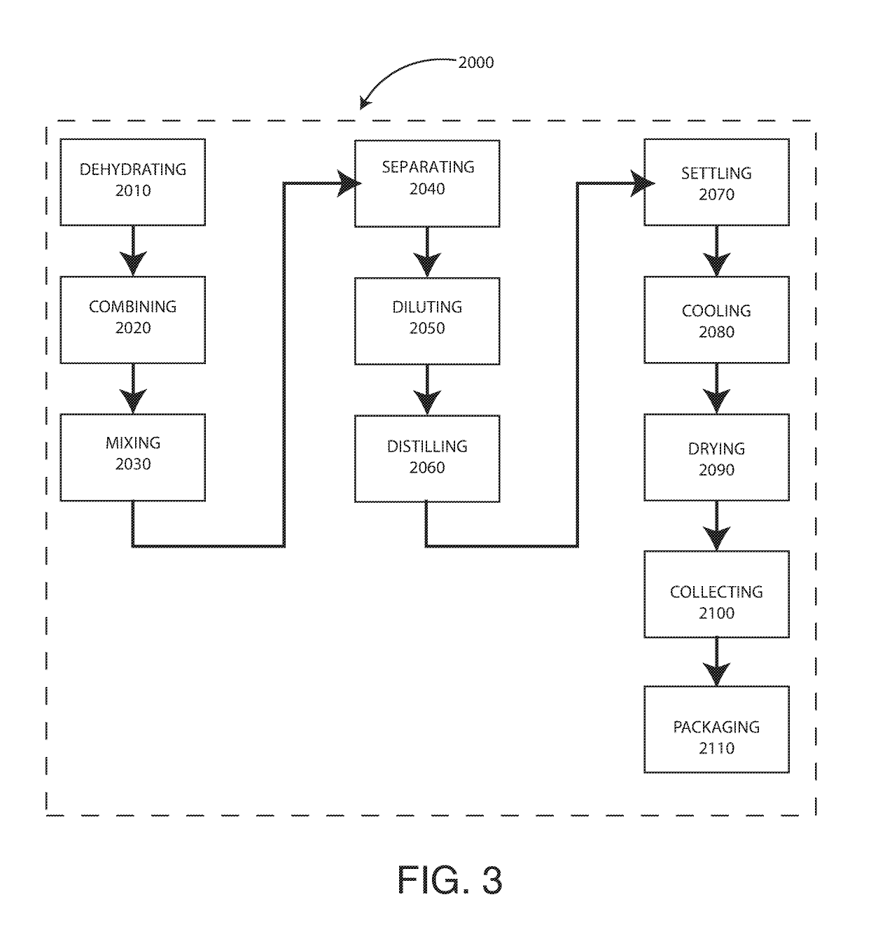

Certain embodiments of the present invention, as shown in FIG. 3, comprise a method 2000 for the extraction of alpha-acids from post-process solids comprising the steps of combining 2020 post-process solids with a solvent, mixing 2030 the combination of the post-process solids with solvent to create a substantially homogenous slurry, separating 2040 a solution from the slurry, diluting 2050 the solution, distilling 2060 the solution, cooling 2080 the solution, and drying 2090 the solution prior to collecting 2100 of dried alpha-acid crystals. Certain embodiments of the present invention comprise a step of packaging 2110 following the step of collecting 2100 of dried alpha acids. It will be appreciated that after steps such as separating 2040 a solution, or distilling 2050 the solution, it may be desired to allow the settling 2070 of a solution for a predetermined period of time. to remove unwanted solids or capture solute, such as alpha-acid crystals, which have precipitated out of solution. Certain embodiments of the present invention comprise allowing a solution to settle for 4-8 hours. In certain embodiments of the present invention, it may be desired for post-process solids to undergo a dehydrating 2010 step prior to the combining 2020 of post-process solids with a solvent.

Certain embodiments comprise combining 2020 a solvent with post-process solids prior to mixing 2030 post-process solids with a solvent. The mixing 2030 helps maximize the dissolving alpha-acids of the post-process solids into solution. Mixing 2030 the combination of post-process solids and solvent creates a slurry comprising post-process solids and a solution. Once mixing 2030 is complete, the solution is separated, 2040, from the slurry, which separates the liquid portion of the slurry from the solid post-process solids. Once the solution is separated from the slurry, the solid portion of the slurry can be discarded. The solution then undergoes diluting 2050 in preparation for distilling 2060. In certain embodiments, dilution 2050 comprises diluting the solution to be 20% water, by volume. It will be appreciated that if a solution comprises water content above 20%, diluting may be omitted.

In certain embodiments as shown in FIG. 3, the solution is brought to a temperature exceeding the boiling temperature of the solvent but not exceeding the boiling temperature of the water. The solvent typically has a lower boiling point than that of water. It will be appreciated that the boiling point of a liquid is the temperature at which the transition from liquid to gas, or gas to liquid, occurs at a given pressure. It will be further appreciated that the boiling point of a given liquid changes dependent upon atmospheric pressure.

Once the solvent is separated from the solution, the resulting solution comprises alpha-acids and water. Some alpha-acids may precipitate out of solution during the cooling 2080, as cooling of the solution lowers the saturation limit of the solvent. The solution then undergoes a settling 2070. Settling 2070 allows alpha-acids that have precipitated out of solution to settle out of suspension within the remaining solution. Once settling 2070 is complete, the solution undergoes drying 2090 to remove the water content and dry the remaining alpha-acid crystals in preparation for the collecting step.

In certain embodiments, drying 2090 comprises pressurized delivery of a solution through a spray nozzle in a dry environment to evaporate the water from the solution, leaving crystalline alpha-acids. The spray nozzle, is directed into a collection vessel where the crystalline alpha-acids are deposited along the internal surfaces of the collection vessel. In such embodiments, collecting 2100 may involve the scraping of crystalline alpha acids from the collection vessel walls for packaging. Scraping of the crystalline alpha-acids can be performed with a variety of different objects and materials, but is typically performed with a food grade, durable and flexible product such as polytetrafluoroethylene (PTFE) sheet material. Once the crystalline alpha-acids are collected, the crystalline alpha-acids are packaged. Packaging 2110 generally seals the crystalline alpha-acids from the ambient environment to prevent unwanted exposure to factors such as moisture.

While various embodiments the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A system for the extraction of alpha-acids from post-process solids comprising:
a mixing mechanism comprising a reservoir and a mixing element disposed therein;
the reservoir having connection to a dehydrator;
a distilling mechanism comprising an output having connection to a holding vessel;
a drying mechanism having a drying chamber further comprising a nozzle configured to spray into the drying chamber;
an air-heater configured to heat air entering the drying chamber; and
the drying mechanism further comprising a first collection vessel connected to the drying chamber;
wherein the mixing reservoir is configured to receive solids and a solvent for mixing in order to dissolve alpha-acids into a solution comprising solvent, water and alpha-acids;
wherein the dehydrator is configured to separate the solution from the solids,
wherein the distilling mechanism is configured to separate the solvent from the solution,
and
wherein drying mechanism is configured to separate the alpha-acids from the solvent.

2. The system of claim 1, wherein an air-pump has connection to the drying mechanism.

3. The system of claim 2, wherein the air-pump is configured to induce a negative air-flow, thereby drawing air though the air-heater and into the drying chamber.

4. The system of claim 3 wherein, the air-heater is configured to induce a cyclonic air-flow within the drying chamber.

5. The system of claim 4, wherein the nozzle comprises a spinning nozzle configured to provide 360-degree delivery of droplets.

6. The system of claim 5, further comprising a cyclonic separator connected to the drying chamber, wherein the cyclonic separator is connected downstream of the drying chamber.

7. The system of claim 6, wherein the cyclonic separator further comprises a second collection vessel.

8. The system of claim 2, further comprising a cyclonic separator connected to the drying chamber, wherein the cyclonic separator is connected downstream of the drying chamber.

9. The system of claim 8, wherein the cyclonic separator further comprises a second collection vessel.

10. The system of claim 9, further comprising a pump configured to deliver the solution to the nozzle.

11. The system of claim 10, further comprising a holding vessel wherefrom the pump draws the solution to deliver to the nozzle.

12. A method for the extraction of alpha-acids from post-process solids comprising the steps of:
combining a plant-based material with a solvent to produce a slurry;
dehydrating the plant-based material;
mixing the slurry to dissolve alpha-acids from the plant-based material with the solvent, resulting in a solution comprising the solvent and the alpha-acids;
separating the solution from the plant-based material;
distilling the solution to remove the solvent from the solution;
drying the solution through pressurized delivery of the solution through a nozzle into a dry environment to evaporate the water from the alpha-acids; and
collecting the alpha-acids.

13. The method of claim 12, wherein a step of diluting the solution with water occurs prior to the distilling step.

14. The method of claim 12, wherein a step of settling the solution occurs prior to the drying step.

15. The method of claim 12, wherein a step of cooling the solution occurs prior to the drying step.
